(19) United States
(12) Patent Application Publication
(10) Pub. No.: US 2022/0103040 A1
(43) Pub. Date: Mar. 31, 2022

(54) MOTOR HOUSING ASSEMBLY FOR CEILING FAN

(71) Applicant: Kuo-Tsun Lin, Taichung City (TW)

(72) Inventor: Kuo-Tsun Lin, Taichung City (TW)

(21) Appl. No.: 17/488,269

(22) Filed: Sep. 28, 2021

(30) Foreign Application Priority Data
Sep. 30, 2020 (TW) 109134268

(51) Int. Cl. H02K 5/10; F04D 25/08; F04D 29/64

(52) U.S. Cl. CPC H02K 5/10; F04D 29/646; F04D 25/088

(57) ABSTRACT

A motor housing assembly for a ceiling fan includes a lower housing member, an upper housing member, and a fastener. The lower housing member includes a bottom wall and a first surrounding wall that extends upward from the bottom wall and that has an outward surface formed with an outer thread. The upper housing member includes a top wall and a second surrounding wall that extends downward from the top wall, that surrounds the first surrounding wall, and that has an inside surface formed with an inner thread. The fastener is positioned between the second surrounding wall and the first surrounding wall, and prevents relative rotation between the lower housing member and the upper housing member.

### CROSS-REFERENCE TO RELATED APPLICATIONS

This application claims priority of Taiwanese Invention Patent Application No. 109134268, filed on Sep. 30, 2020.

### FIELD

The disclosure relates to a ceiling fan, more particularly to a motor housing assembly for a ceiling fan.

### BACKGROUND

Referring to FIG. 1, a conventional motor housing 5 of a ceiling fan includes a flanged upper cover 51, a flanged lower cover 52, an intermediate surrounding wall 53 extending between the flanged upper cover 51 and the flanged lower cover 52, and a plurality of bolts 54 fixing the upper cover 51 and the lower cover 52 through their flanges. However, this conventional motor housing 5 has the disadvantage of inconvenient assembly due to the multiplicity of components.

Referring to FIG. 2, another existing motor housing 6 includes a housing base 61, and a housing cover 62 fitted on the housing base 61. The housing cover 62 has a surrounding wall 621 formed with a plurality of first fastener holes 622. The housing base 61 has a flange portion 611 formed with a plurality of second fastener holes 612. The housing cover 62 is fixed to the housing base 61 with a plurality of fasteners 63 passing through the first fastener holes 622 and the second fastener holes 612.

However, this existing motor housing 6 shown in FIG. 2 has the following disadvantages:

1. During assembly, it is troublesome to align the first fastener holes 622 with the second fastener holes 612, which affects the assembly efficiency.

2. The respective hole pitch tolerances of the first fastener holes 622 and the second fastener holes 612 may cause a gap to form between the junction of the housing base 61 and the housing cover 62 after being fastened, which will affect the aesthetic appearance of the motor housing 6, and which will not effectively protect against dust or moisture. Moreover, when the motor housing 6 is rotated with a motor rotor, the stress generated at the junction of the housing base 61 and the housing cover 62 increases, and may cause damage to the motor housing 6.

### SUMMARY

Therefore, the object of the present invention is to provide an uncomplicated housing assembly that has a simple structure and that can be quickly assembled, thus improving assembly efficiency.

According to the disclosure, a motor housing assembly for a ceiling fan includes a lower housing member, an upper housing member, and a fastener. The lower housing member includes a bottom wall and a first surrounding wall that extends upward from a periphery of the bottom wall and that has an outward surface formed with an outer thread. The upper housing member includes a top wall and a second surrounding wall that extends downward from the periphery of the top wall, that surrounds the first surrounding wall of the lower housing member, and that has an inside surface formed with an inner thread for threadedly engaging with the outer thread, and an outside surface opposite to the inside surface. The fastener is positioned between the second surrounding wall of the upper housing member and the first surrounding wall of the lower housing member, and prevents relative rotation between the lower housing member and the upper housing member.

### BRIEF DESCRIPTION OF THE DRAWINGS

Other features and advantages of the disclosure will become apparent in the following detailed description of the embodiment with reference to the accompanying drawings, of which:

FIG. 1 is a cross-sectional view of a conventional motor housing for a ceiling fan;

FIG. 2 is a cross-sectional view of another conventional motor housing for a ceiling fan;

FIG. 3 is an exploded perspective view of an embodiment of a motor housing assembly for a ceiling fan according to the disclosure;

FIG. 4 is an assembled perspective view of the embodiment; and

FIG. 5 is a schematic cross-sectional view of the embodiment.

### DETAILED DESCRIPTION

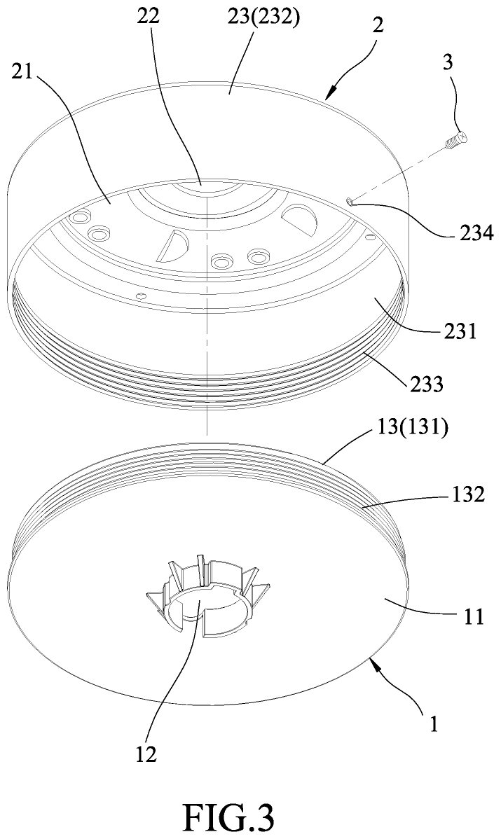

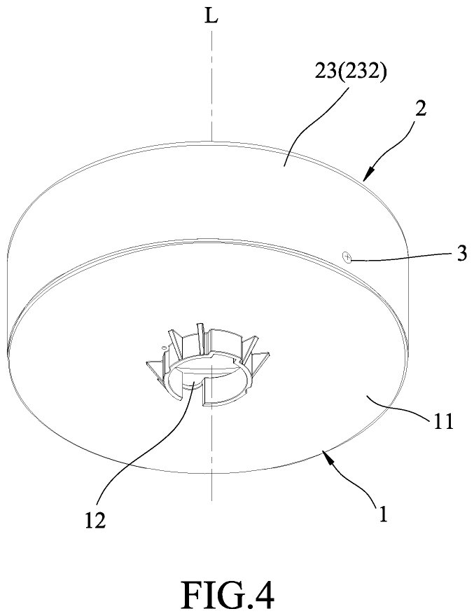

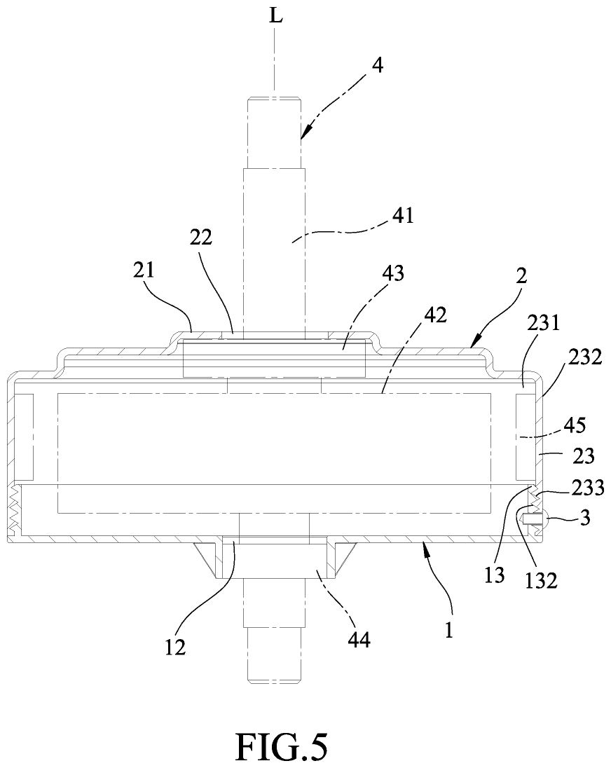

As shown in FIGS. 3, 4, and 5, an embodiment of a motor housing assembly for a ceiling fan according to the present disclosure is adapted to cover a motor unit 4. The motor housing assembly includes a lower housing member 1, an upper housing member 2, and a fastener 3.

The lower housing member 1 includes a disc-shaped bottom wall 11 transverse to an axis (L) which extends along an up-down direction, and a first surrounding wall 13 extending upward from a periphery of the bottom wall 11. The bottom wall 11 is formed with a lower shaft hole 12 at the axis (L). The first surrounding wall 13 has an outward surface 131 formed with an outer thread 132.

The upper housing member 2 includes a disk-shaped top wall 21 transverse to the axis (L), and a second surrounding wall 23 extending downward from a periphery of the top wall 21, and surrounding the first surrounding wall 13 of the lower housing member 1. The top wall 21 is formed with an upper shaft hole 22 at the axis (L). The second surrounding wall 23 has an inside surface 231 formed with an inner thread 233 threadedly engaging with the outer thread 132 of the first surrounding wall 13, and an outside surface 232 opposite to the inside surface 231. The second surrounding wall 23 includes a mounting portion 234 formed on the outside surface 232. In this embodiment, the mounting portion 234 is an indentation used as a place marker.

The fastener 3 is positioned between the second surrounding wall 23 of the upper housing member 2 and the first surrounding wall 13 of the lower housing member 1. In this embodiment, the fastener 3 is a self-tapping screw, and is screwed through the second surrounding wall 23 of the upper housing member 2 via the mounting portion 234 and is fixed with the first surrounding wall 13 of the lower housing member 1, thereby preventing relative rotation between the lower housing member 1 and the upper housing member 2. In other variations of this embodiment, the mounting portion 234 may be a hole (not shown) extending from the outside surface 232 to the inside surface 231, and the fastener 3 may be a nail (not shown) extending through the second surrounding wall 23 via the mounting portion 234 and nailed into the first surrounding wall 13.

The motor unit 4 includes a shaft 41, a stator 42, an upper bearing 43, a lower bearing 44, and a rotor 45. When the motor unit 4 is coupled to the motor housing assembly of the disclosure, the shaft 41 extends along the axis (L) and passes through the upper shaft hole 22 of the upper housing member 2 and the lower shaft hole 12 of the lower housing member 1, the stator 42 is disposed between the upper housing member 2 and the lower housing member 1 and surrounds the shaft 41, the upper bearing 43 is located adjacent to the upper shaft hole 22 and sleeved on the shaft 41, the lower bearing 44 is located adjacent to the lower shaft hole 12 and sleeved on the shaft 41, and the rotor 45 is mounted on the inside surface 231 of the second surrounding wall 23 of the upper housing member 2 and surrounds the stator 42. The rotor 45, the upper housing member 2, and the lower housing member 1 rotate as a whole relative to the stator 42.

Through the above description, the advantages of the present disclosure can be summarized as follows:

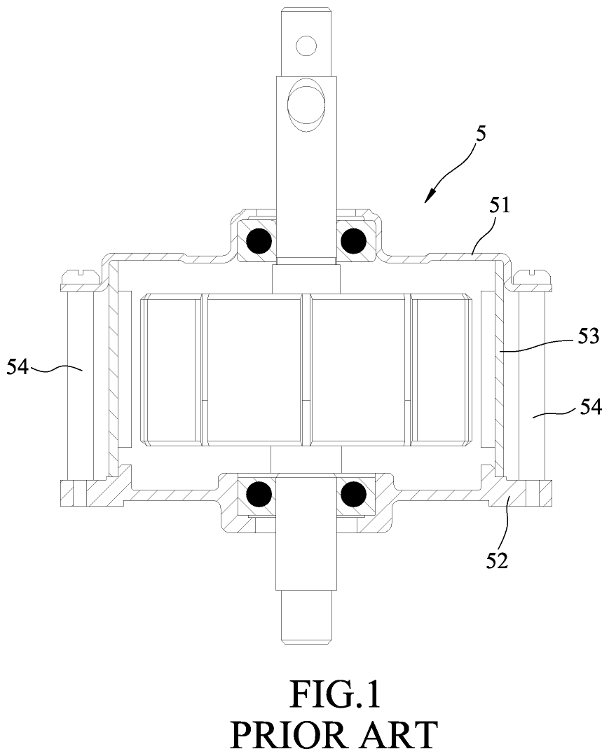

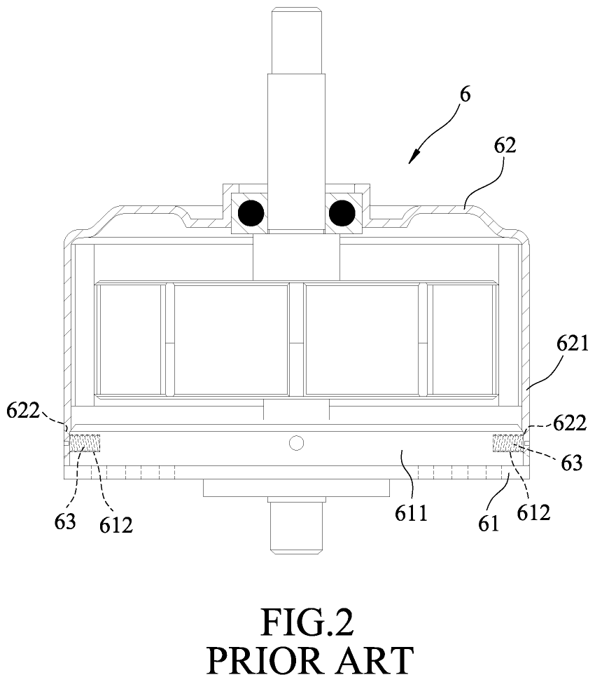

1. The upper housing member 2 and the lower housing member 1 are threadedly coupled to each other, and through the mounting portion 234 accessible on the outside surface 232 of the second surrounding wall 23, the fastener 3 can be inserted through the second surrounding wall 23 of the upper housing member 2 via the mounting portion 234 of the second surrounding wall 23 of the upper housing member 2 to complete the assembly of the lower housing member 1 and the upper housing member 2. The threaded coupling can prevent relative rotation between the lower housing member 1 and the upper housing member 2. Compared with the two aforementioned conventional motor housings shown in FIGS. 1 and 2, the motor housing assembly according to the disclosure can avoid the inconvenience of misalignment of the fasteners and fastening holes, thereby improving the assembly efficiency and reducing the number of fasteners and fastening holes of the lower and upper housing members 1, 2. In another aspect, it simplifies the manufacturing process of the lower and upper housing members 1, 2, reduces the manufacturing cost, and increases overall structural strength.

2. Since the upper housing member 2 and the lower housing member 1 are threadedly coupled to each other, relative movement between the upper housing member 2 and the lower housing member 1 along the axis (L) can be reduced. The gap between the second surrounding wall 23 of the upper housing member 2 and the first surrounding wall 13 of the lower housing member 1 can be reduced too, which is not only more aesthetically pleasing but also protects the motor housing assembly from dust and moisture and increases the service life of the motor unit 4. When the upper housing member 2 and the lower housing member 1 are rotated integrally with the rotor 45, the stress generated at the junction of the second surrounding wall 23 and the first surrounding wall 13 can also be reduced, so that the likelihood of deformation or cracking of the upper housing member 2 and the lower housing member 1 can be reduced.

In summary, the motor housing assembly of the ceiling fan of the present invention can indeed achieve the purpose of the present invention.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A motor housing assembly for use in a ceiling fan, comprising:
a lower housing member including a bottom wall and a first surrounding wall that extends upward from a periphery of said bottom wall and that has an outward surface formed with an outer thread;
an upper housing member including a top wall and a second surrounding wall that extends downward from a periphery of said top wall, that surrounds said first surrounding wall of said lower housing member, and that has an inside surface formed with an inner thread threadedly engaging with said outer thread of said first surrounding wall of said lower housing member, and an outside surface opposite to and surrounding said inside surface; and
a fastener positioned between said second surrounding wall of said upper housing member and said first surrounding wall of said lower housing member, and preventing relative rotation between said lower housing member and said upper housing member.

2. The motor housing assembly as claimed in claim 1, wherein said second surrounding wall includes a mounting portion formed on said outside surface, said fastener extending through said second surrounding wall via said mounting portion and extending trough said first surrounding wall.

3. The motor housing assembly as claimed in claim 2, wherein said mounting portion is an indentation on said outside surface of said second surrounding wall, said fastener being a self-tapping screw that is screwed through said second surrounding wall via said mounting portion and fixed with said first surrounding wall.

4. The motor housing assembly as claimed in claim 2, wherein said mounting portion is a hole extending from said outside surface to said inside surface of said second surrounding wall, said fastener being a nail that extends through said second surrounding wall via said mounting portion and fixed with said first surrounding wall.
